(19) United States
(12) Patent Application Publication
(10) Pub. No.: US 2025/0204520 A1
(43) Pub. Date: Jun. 26, 2025

(54) USE OF SODIUM SELENITE IN PREVENTION AND/OR ALLEVIATION OF TEA TREE SUNBURN

(71) Applicant: ANHUI AGRICULTURAL UNIVERSITY, Hefei City (CN)

(72) Inventors: Jiayue JIANG, HEFEI CITY (CN); Xiaoyan ZENG, HEFEI CITY (CN); Xingchen LI, HEFEI CITY (CN); Wenjun FU, HEFEI CITY (CN); Gan HU, HEFEI CITY (CN); Junlong YANG, HEFEI CITY (CN); Shijun YANG, HEFEI CITY (CN); Qingqing YUAN, HEFEI CITY (CN); Yeyun LI, HEFEI CITY (CN); Zhougao SHEN, HEFEI CITY (CN); Xianchen ZHANG, HEFEI CITY (CN)

(21) Appl. No.: 18/680,835

(22) Filed: May 31, 2024

(30) Foreign Application Priority Data
Dec. 22, 2023 (CN) 202311781272.5

(51) Int. Cl. A01N 3/00; A01N 59/02; A01P 15/00

(52) U.S. Cl. CPC A01N 3/00; A01N 59/02; A01P 15/00

(57) ABSTRACT

Tea tree cultivation, and specifically relates to use of sodium selenite in prevention and/or alleviation tea tree sunburn in the prevention and/or alleviation tea tree sunburn. Specifically, the sodium selenite is applied to the tea tree to prevent and/or alleviate sunburn of the tea tree, avoid damage(s) caused by high temperature and drought weather to the tea tree, and reduce losses caused by the sunburn. The method for preventing and/or alleviating tea tree sunburn using sodium selenite is simple to operate and highly efficient. Compared with the existing methods of shading, reasonable dense planting, soil cultivation, drought prevention, and timely irrigation, the method in the present disclosure shows lower economic and labor costs, such that tea farmers can achieve a higher profit.

### CROSS REFERENCE TO RELATED APPLICATION

This patent application claims the benefit and priority of Chinese Patent Application No. 2023117812725, filed with the China National Intellectual Property Administration on Dec. 22, 2023, the disclosure of which is incorporated by reference herein in its entirety as part of the present application.

### TECHNICAL FIELD

The present disclosure belongs to the technical field of tea tree cultivation, and specifically relates to use of sodium selenite in prevention and/or alleviation tea tree sunburn.

### BACKGROUND

Sunburn is a physiological disease, which can be divided into browning type, sun-scald type, and photooxidative type sunburn according to the severity of plant damages. High temperatures and strong light are the main causes of sunburn in plants. The sunburn causes significant changes in the contents of soluble substances, malondialdehyde, antioxidant enzymes, chlorophyll, and carotenoids in plant fruits and leaves, causing browning of the fruit and leaf surfaces, and reducing fruit yield and quality. For tea trees, sunburn causes discoloration of tea leaves and a decrease in tea quality. In severe cases, the sunburn can cause large areas of tea trees to die, reduce tea output, lower tea garden production, and decrease tea farmers' economic benefits. Compared with green tea tree varieties, light-sensitive yellow tea tree varieties are more susceptible to the sunburn.

In the past, approaches to prevent and alleviate sunburn in tea trees mainly included the following: 1) shading and reasonable dense planting: building awnings/nets in tea gardens or interplanting with tall trees can effectively prevent the sunburn; 2) prevention before drought: deep plowing and applying enough special base fertilizer for tea gardens before closing the garden in winter can improve the ability to resist drought as well as the ability to resist sunburn; 3) timely irrigation: in the dry season, the timely irrigation according to situations can ensure the normal transpiration of leaves, thus effectively preventing the sunburn; 4) the root activity is promoted through soil cultivation, such that the plants are strengthened to increase their resistance, which can also prevent sunburn to a certain extent.

However, although the above methods can prevent and alleviate tea tree sunburn to a certain extent, they are all complicated in operation and consume a lot of economic and labor costs, thereby greatly reducing the income of tea farmers and resulting in less overall benefit.

### SUMMARY

An objective of the present disclosure is to provide use of sodium selenite in prevention and/or alleviation tea tree sunburn. In the present disclosure, a process of applying sodium selenite on a tea tree can prevent and/or alleviate sunburn of the tea tree, and this process has a simple operation with high efficiency, low labor and economic costs, and high benefits to tea farmers.

The present disclosure provides use of sodium selenite in prevention and/or alleviation tea tree sunburn.

Preferably, the sodium selenite is applied in the form of a sodium selenite solution, and the sodium selenite solution has a concentration of 1.0 mg/L to 4.0 mg/L.

Preferably, an application process of the sodium selenite includes foliar spraying.

The present disclosure further provides a method for preventing and/or alleviating tea tree sunburn, including the following steps:

applying sodium selenite to a tea tree.

Preferably, the sodium selenite is applied in the form of a sodium selenite solution, and the sodium selenite solution has a concentration of 1.0 mg/L to 4.0 mg/L.

Preferably, an application process of the sodium selenite includes foliar spraying.

Preferably, the foliar spraying is conducted once a day for 3 to 5 consecutive days.

Preferably, the foliar spraying is conducted until there are liquid droplets falling from leaves of the tea tree.

Preferably, a nozzle has a vertical distance of 3 cm to 5 cm from a leaf surface of the tea tree during the foliar spraying.

Preferably, the foliar spraying is conducted 5 d to 7 d before a high-temperature weather occurs, and the high-temperature weather has a daily maximum temperature of not less than 34° C.

### Beneficial Effects

The present disclosure provides use of sodium selenite in prevention and/or alleviation tea tree sunburn. Specifically, the sodium selenite is applied to the tea tree to prevent and/or alleviate sunburn of the tea tree, avoid damages caused by high temperature and drought weather to the tea tree, and then reduce losses caused by the sunburn. The method for preventing and/or alleviating tea tree sunburn using sodium selenite is simple to operate and highly efficient. Compared with the existing methods of shading, reasonable dense planting, soil cultivation, drought prevention, and timely irrigation, the method in the present disclosure shows lower economic and labor costs, such that the tea farmers can achieve a higher profit.

### BRIEF DESCRIPTION OF THE DRAWINGS

To illustrate the examples of the present disclosure or the technical solutions in the prior art more clearly, the accompanying drawings required in the examples will be briefly introduced below.

FIG. 1 shows the Fv/Fm value of tea trees treated with exogenous selenium at different concentrations under sunburn in Example 1; and

FIG. 2 shows the malondialdehyde (MDA) content of tea trees treated with exogenous selenium under sunburn in Example 2.

### DETAILED DESCRIPTION OF THE EMBODIMENTS

The present disclosure provides use of sodium selenite in prevention and/or alleviation tea tree sunburn.

In the present disclosure, the sodium selenite is preferably used in the form of a sodium selenite solution, and the sodium selenite solution has a concentration of preferably (1.0-4.0) mg/L, more preferably (2.0-3.0) mg/L, and even more preferably 3.0 mg/L. There is no special limitation on a preparation method of the sodium selenite solution, and a sodium selenite solution of corresponding concentration can be prepared using conventional methods in the field. An application method of the sodium selenite preferably includes foliar spraying.

Specifically, the present disclosure further provides a method for preventing and/or alleviating tea tree sunburn, including the following steps: applying sodium selenite to a tea tree.

In the present disclosure, sodium selenite is applied in the form of a sodium selenite solution, and the sodium selenite solution has a concentration of (1.0-4.0) mg/L, preferably (2.0-3.0) mg/L, and more preferably 3.0 mg/L. An application method preferably includes foliar spraying, and a frequency of the foliar spraying is preferably once a day, with continuous spraying for 3 d to 5 d, and more preferably 4 d; and the foliar spraying is conducted until there are liquid droplets falling from leaves of the tea tree. A nozzle has a vertical distance of 3 cm to 5 cm from a leaf surface of the tea tree during the foliar spraying. The foliar spraying is preferably conducted between 7 and 9 a.m. or between 4 and 6 p.m. while avoiding spraying at noon to reduce a spraying effect.

In the present disclosure, the foliar spraying of the sodium selenite is conducted preferably 5 d to 7 d, more preferably 6 d before a high-temperature weather occurs, and the high-temperature weather has a daily maximum temperature of preferably not less than 34° C. The daily maximum temperature is preferably based on a weather forecast.

In the present disclosure, the sodium selenite is applied to the tea tree to prevent and/or alleviate sunburn of the tea tree, avoid damages caused by high temperature and drought weather to the tea tree, and then reduce losses caused by the sunburn. The method for preventing and/or alleviating tea tree sunburn using sodium selenite has simple operation and high efficiency. This process demonstrates the simplicity and implementability of the method of the present disclosure. Compared with the existing methods of shading, reasonable dense planting, soil cultivation, drought prevention, and timely irrigation, the method in the present disclosure shows lower economic and labor costs, such that tea farmers can achieve a higher profit.

In order to further illustrate the present disclosure, the technical solutions provided by the present disclosure are described in detail below in connection with accompanying drawings and examples, but these examples should not be understood as limiting the claimed scope of the present disclosure.

### Example 1

A method for preventing and/or alleviating tea tree sunburn included:
Experimental base: artificial climate chamber of Anhui Agricultural University;
Experimental subjects: ‘Huangjinye’ tea tree variety;
Experimental procedure:

1. Material collection: a test material was the tea tree variety ‘Huangjinye’, where the tea seedlings grew uniformly, were healthy and disease-free, and had a height of 30 cm.

2. Preparation of Na2SeO3 treatment solutions with different concentrations: 1.0, 2.0, 3.0, and 4.0 mg sodium selenite crystal powders were dissolved in 1 L of pure water (with final concentrations of 1.0, 2.0, 3.0, and 4.0 mg/L, respectively).

3. Seedling cultivation: the purchased tea seedlings were planted in a flower pot with a diameter of 20 cm, where nutrient soil, vermiculite, and perlite were at a volume ratio of 2:1:1; growth environment: temperature 28° C., humidity 80%, and light intensity 500 μmol·m⁻²·s⁻¹.

4. Anti-sunburn test of different concentrations of selenium: tea seedlings with roughly the same growth rate were sprayed with 0, 1.0, 2.0, 3.0, and 4.0 mg/L sodium selenite solution on the surface of their leaves at a distance of 3 cm to 5 cm from the leaves until liquid droplets were falling from the leaves, spray once a day for continuous 4 days; while a control group was sprayed with the same amount of water.

After an interval of 2 d after the end of the external treatment, the tea seedlings were placed in an artificial climate chamber (temperature: 34° C., humidity: 60%, light intensity: 1600 μmol·m⁻²·s⁻¹) to allow simulated sunburn treatment for 4 h, and then observed, photographed, and statistics were made.

### 5. Experimental Results:

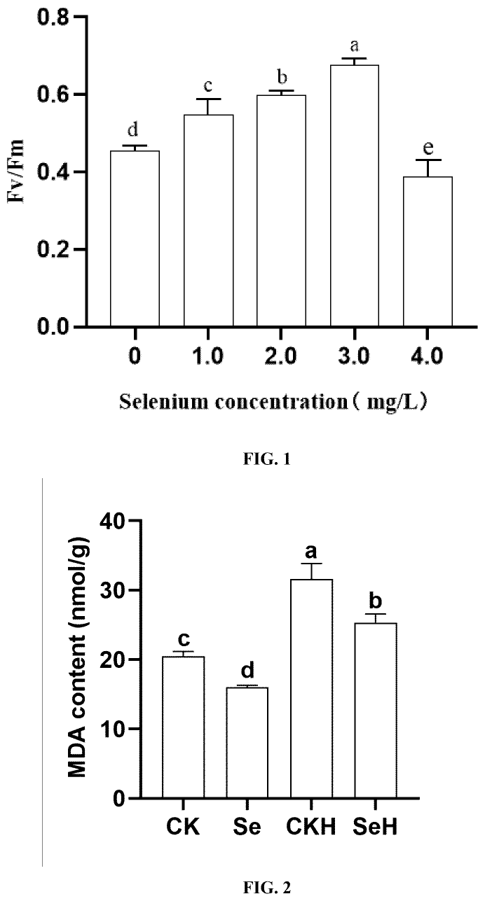

Influences of different concentrations of selenium on the apparent morphology of tea trees under sunburn: compared with the selenium treatment group, the water treatment group had the largest number of burned leaves and the largest lesion area. Among the four spraying concentrations, as the concentration of exogenous selenium increased, the number of sunburned leaves and the area of diseased spots on tea trees showed a trend of first decreasing and then increasing. Among them, the sunburned leaves of tea trees had the least amount and the smallest lesion area at a concentration of 3.0 mg/L. The results in FIG. 1 showed that compared with the control CK, the Fv/Fm value of the tea trees in the water treatment group decreased by 42.09% under sunburn conditions, the Fv/Fm values of tea trees in the treatment groups with selenium concentrations of 1.0, 2.0, 3.0 and 4.0 mg/L decreased by 30.29%, 23.72%, 17.86%, and 34.32%, respectively. The decrease in Fv/Fm value of tea trees in the 4 selenium treatment groups was smaller than that in the water treatment group, where the Fv/Fm value of the treatment with a selenium concentration of 3.0 mg/L had the minimum decrease. Moreover, external spraying of sodium selenite could indeed alleviate the tea tree sunburn, and 3.0 mg/L Na2SeO3 solution had the best effect.

The influences of different concentrations of selenium on disease index of the sunburn in tea trees were shown in Table 1. The number of leaves at each disease level was counted according to the degree of disease susceptibility, and the average incidence rate and disease index were calculated according to the formula to determine the severity of tea leaf diseases. The classification standards for tea tree sunburn disease were shown in Table 2. Incidence rate=number of diseased leaves/total number of investigated leaves×100%, disease index=[Σ(number of leaves at each disease level×representative value of disease level)/(total number of investigated leaves×representative value of highest level)]×100; control effect (%)=[(control group condition index-treatment group condition index)/control group condition index]×100%.

TABLE 1
Influences of different concentrations of selenium
on sunburn disease index of tea trees

| Selenium | Disease | Incidence | Efficacy |
|---|---|---|---|
| concentration (mg/L) | index | (%) | (%) |
| 0 | 1.97 ± 0.05a | 18.30 ± 2.23a | — |
| 1.0 | 1.13 ± 0.26bc | 12.11 ± 3.38b | 42.61 |
| 2.0 | 1.13 ± 0.35bc | 12.88 ± 0.66ab | 42.61 |
| 3.0 | 0.22 ± 0.08d | 4.00 ± 0.00d | 89.38 |
| 4.0 | 1.62 ± 0.23ab | 16.50 ± 3.80a | 17.58 |

Note:
different letters in the table indicated significant differences (P < 0.05).

TABLE 2
Grading standards for sunburn of tea tree

| Grade of | Disease level | Representative |
|---|---|---|
| disease | standards | value |
| I | The whole leaf was normal without lesions | 0 |
| II | The affected leaves began to change | 1 |
| | color from the tip to the edge, with | |
| | lesion area ≤¼ | |
| III | ¼< lesions occupying leaf area ≤½ | 2 |
| IV | ½< lesions occupying leaf area ≤¾ | 3 |
| V | Area of lesion >¾, and the entire leaf died | 4 |

As shown in Table 1, compared with the group without selenium treatment, the incidence of sunburn in tea trees with selenium concentrations of 1.0, 2.0, 3.0, and 4.0 mg/L was reduced by 33.83%, 29.62%, and 78.14%, and 9.84%, and their control effects were 42.61%, 42.61%, 89.38%, and 17.58%, respectively. The results showed that external spraying of 3.0 mg/L sodium selenite had the lowest incidence of sunburn and the best effect in preventing sunburn in tea trees.

### Example 2

A method for preventing and/or alleviating tea tree sunburn included:
Experimental base: artificial climate chamber of Anhui Agricultural University;
Experimental subjects: ‘Huangjinye’ tea tree variety;

1. Material collection: a test material was the tea tree variety ‘Huangjinye’, where the tea seedlings grew uniformly, were healthy and disease-free, and had a height of 30 cm.

2. Preparation of Na₂SeO₃ treatment solution: 3.0 mg sodium selenite crystal powder was dissolved in 1 L of pure water (concentration: 3.0 mg/L).

3. Seedling growth environment: the purchased tea seedlings were planted in a flower pot with a diameter of 20 cm (nutrient soil, vermiculite, and perlite) were at a volume ratio of 2:1:1, and then placed in a glass greenhouse.

Normal growth environment: temperature 28° C., humidity 80%, and light intensity500 μmol·m⁻²·s⁻¹.

Sunburn-simulated environment: temperature 34° C., humidity 60%, and light intensity 1,600 μmol·m⁻²·s⁻¹.

4. Test of sunburn and no sunburn after simulated spraying of sodium selenite: sodium selenite aqueous solution with a concentration of 3 mg/L was sprayed, and placed in a normal growth environment and a simulated sunburn environment, respectively.

The test groups were Se (no sunburn after treatment with 3 mg/L Na₂SeO₃) and SeH (with sunburn after treatment with 3 mg/L Na₂SeO₃).

The control groups were CK (no sunburn after water treatment) and CKH (sunburn after water treatment), and the control group was sprayed with the same amount of water as the test group.

Experimental Results were as Follows:

The influence of exogenous selenium on the malondialdehyde (MDA) content of tea trees under sunburn was shown in FIG. 2. The determination method of malondialdehyde (MDA) was:

After sunburn treatment for 4 h, 0.5 g samples of the 3rd and 4th leaves of mature tea tree leaves were added in a mortar separately, added with 5 mL of 5% (v/v) trichloroacetic acid and ground. The leaves were ground into a slurry, collected in a centrifuge tube, and centrifuged at 4,000 r/min for 10 min at room temperature. 3 mL of 0.5% (m/v) thiobarbituric acid was added into 2 mL of supernatant in a centrifuge tube and shaken gently for 15 s. The pure water was regarded as the control group. The mixed solution was placed in a water bath and heated at 100° C. for 15 min. After rapid cooling and centrifugation at 4,000 r/min for 10 min, a supernatant was detected using a UV spectrophotometer at 523 nm, 600 nm, and 450 nm separately, and the data were recorded and analyzed. A calculation formula was as follows: MDA content (μmol·g⁻¹)=[6.45×(OD₅₃₂−OD₆₀₀)−0.56×OD₄₅₀]×V/1000).

In the formula, V=volume of extraction liquid (mL); =fresh weight of sample (g).

As shown in FIG. 2, after tea trees were sprayed with selenium and grown under non-sunburn growth conditions, the MDA content in the selenium-treated group was significantly reduced compared with the control, by 22.14%. Compared with the water treatment group under sunburn, the MDA content in the selenium treatment group decreased significantly, by 19.89%. The results showed that exogenous spraying of sodium selenite could reduce the accumulation of MDA content in tea leaves regardless of whether high temperature and drought conditions occurred. This further illustrated that spraying sodium selenite on tea saplings could help enhance the ability of tea trees to resist high temperature and drought stress. At the same time, it was shown that even if high temperature and drought did not occur after spraying sodium selenite, there might be no negative impact on tea trees.

It is concluded from the above examples that spraying sodium selenite from an external source can effectively prevent and alleviate the tea tree sunburn, and is highly operable and easy to implement.

Although the above example has described the present disclosure in detail, it is only a part of, not all of, the examples of the present disclosure. Other examples may also be obtained by persons based on the example without creative efforts, and all of these examples shall fall within the protection scope of the present disclosure.

What is claimed is:

1. A method for preventing and/or alleviating tea tree sunburn, comprising the following steps:
applying sodium selenite to a tea tree.

2. The method according to claim 1, wherein the sodium selenite is applied in the form of a sodium selenite solution, and the sodium selenite solution has a concentration of 1.0 mg/L to 4.0 mg/L.

3. The method according to claim 2, wherein an application process of the sodium selenite comprises foliar spraying.

4. The method according to claim 3, wherein the foliar spraying is conducted once a day for 3 to 5 consecutive days.

5. The method according to claim 4, wherein the foliar spraying is conducted until there are liquid droplets falling from leaves of the tea tree.

6. The method according to claim 3, wherein a nozzle has a vertical distance of 3 cm to 5 cm from a leaf surface of the tea tree during the foliar spraying.

7. The method according to claim 1, wherein the foliar spraying is conducted 5 d to 7 d before a high-temperature weather occurs, and the high-temperature weather has a daily maximum temperature of not less than 34° C.

8. The method according to claim 2, wherein the foliar spraying is conducted 5 d to 7 d before a high-temperature weather occurs, and the high-temperature weather has a daily maximum temperature of not less than 34° C.

9. The method according to claim 3, wherein the foliar spraying is conducted 5 d to 7 d before a high-temperature weather occurs, and the high-temperature weather has a daily maximum temperature of not less than 34° C.

10. The method according to claim 4, wherein the foliar spraying is conducted 5 d to 7 d before a high-temperature weather occurs, and the high-temperature weather has a daily maximum temperature of not less than 34° C.

11. The method according to claim 5, wherein the foliar spraying is conducted 5 d to 7 d before a high-temperature weather occurs, and the high-temperature weather has a daily maximum temperature of not less than 34° C.

12. The method according to claim 6, wherein the foliar spraying is conducted 5 d to 7 d before a high-temperature weather occurs, and the high-temperature weather has a daily maximum temperature of not less than 34° C.
